(19) United States
(12) Patent Application Publication
(10) Pub. No.: US 2018/0254978 A1
(43) Pub. Date: Sep. 6, 2018

(54) DATA DELIVERY SYSTEM, COMMUNICATION DEVICE, AND COMMUNICATION CONTROL METHOD

(71) Applicant: Kabushiki Kaisha Toshiba, Minato-ku (JP)

(72) Inventors: Yoshiei SATO, Ota (JP); Makoto Shimamura, Kawasaki (JP); Mototaka Kanematsu, Yokohama (JP)

(73) Assignee: Kabushiki Kaisha Toshiba, Minato-ku (JP)

(21) Appl. No.: 15/876,458

(22) Filed: Jan. 22, 2018

(30) Foreign Application Priority Data
Mar. 6, 2017 (JP) 2017-042196

(51) Int. Cl. H04L 12/707; H04L 12/741; H04L 25/26; H04L 12/751; H04L 12/703

(52) U.S. Cl. CPC H04L 45/22; H04L 45/54; H04L 45/28; H04L 45/02; H04L 25/26

(57) ABSTRACT

The second communication device is in one level higher in a logical network forming a tree structure and sends data to the first communication device. The third communication device is in two or more levels higher in the logical network. The third device is configured to send data to the first communication device without passing through the second communication device. The first communication devices comprises a monitoring unit and a connection switching unit. The monitoring unit is configured to monitor an operation state of the second communication device. The connection switching unit is configured to send a request for sending data to the third communication device, in a case that the normal operation state of the second communication device is not confirmed by the monitoring unit.

### BACKGROUND OF THE INVENTION

### Field of the Invention

The present invention relates to a data delivery system, a communication device, and a communication control method.

### Description of Related Art

Data delivery systems which deliver information from an information deliverer to a terminal device are in practical use. In a data delivery system, redundancy of communication devices on a delivery path is conceived such that information delivery is not suspended even when a communication failure occurs. However, since network scale is expected to increase in the recent Internet of things (IoT) world, costs will increase when redundancy of communication devices is achieved in application to IoT. Furthermore, in conventional technologies, monitoring is performed from a higher side in data delivery, and thus there are cases in which an alternative communication path cannot be specified when not all communication paths are known on the higher side.

### PATENT DOCUMENTS

[Patent Document 1] Japanese Unexamined Patent Application, First Publication No. 2014-183501

### SUMMARY OF THE INVENTION

An object of the present invention is to provide a data delivery system, a communication device, and a communication control method which can rapidly switch to an alternative path when an abnormality occurs.

A data delivery system comprises a plurality of communication devices. The plurality of communication devices comprises a first communication device, a second communication device, and a third communication device. The system performs data delivery using a logical network forming a tree structure. The second communication device is in one level higher than the first communication device in the logical network and sends data to the first communication device. The third communication device is in two or more levels higher in the logical network. The third device is configured to send data to the first communication device without passing through the second communication device. The first communication devices comprises a monitoring unit and a connection switching unit. The monitoring unit is configured to monitor an operation state of the second communication device. The connection switching unit is configured to send a request for sending data to the third communication device, in a case that the normal operation state of the second communication device is not confirmed by the monitoring unit.

### BRIEF DESCRIPTION OF THE DRAWINGS

FIG. 1 is a diagram illustrating a logical network forming a tree structure formed by a data delivery system of embodiments.

FIG. 2 is a diagram illustrating an example of a physical network formed by a data delivery system.

FIG. 3 is a block diagram of a root broker RB.

FIG. 4 is a diagram illustrating an example of content of data registered in an apparatus management table 12.

FIG. 5 is a diagram illustrating an example of content of data registered in a topic management table 23.

FIG. 6 is a block diagram of a sub-broker SB.

FIG. 7 is a block diagram of a client CL.

FIG. 8 is a diagram illustrating a state in which an apparatus registration process is performed between brokers.

FIG. 9 is a diagram illustrating a state in which an apparatus registration process is performed between a client and a broker.

FIG. 10 is a diagram illustrating an example of information set in an apparatus management table 12 of each communication device in a data delivery network in a certain form.

FIG. 11 is a diagram illustrating a state in which a certain event is delivered to a client CL in the data delivery network in the same form as that of FIG. 10.

FIG. 12 is a diagram illustrating a state in which alternative transmission is performed when an abnormality occurs in a certain communication device in the data delivery network in the same form as that of FIG. 10.

FIG. 13 is a flowchart illustrating an example of a first processing flow executed by a communication continuation functional unit 40.

FIG. 14 is a diagram illustrating a state in which a communication device in which an abnormality has occurred is recovered.

FIG. 15 is a diagram illustrating an example in which the data delivery system of embodiments is applied to a traffic signal control system.

### DETAILED DESCRIPTION OF THE INVENTION

Hereinafter, a data delivery system, a communication device, and a communication control method of embodiments will be described with reference to the drawings. In the following description, “corresponding device” refers to a communication device to which the subject belongs.

### Network, Definitions

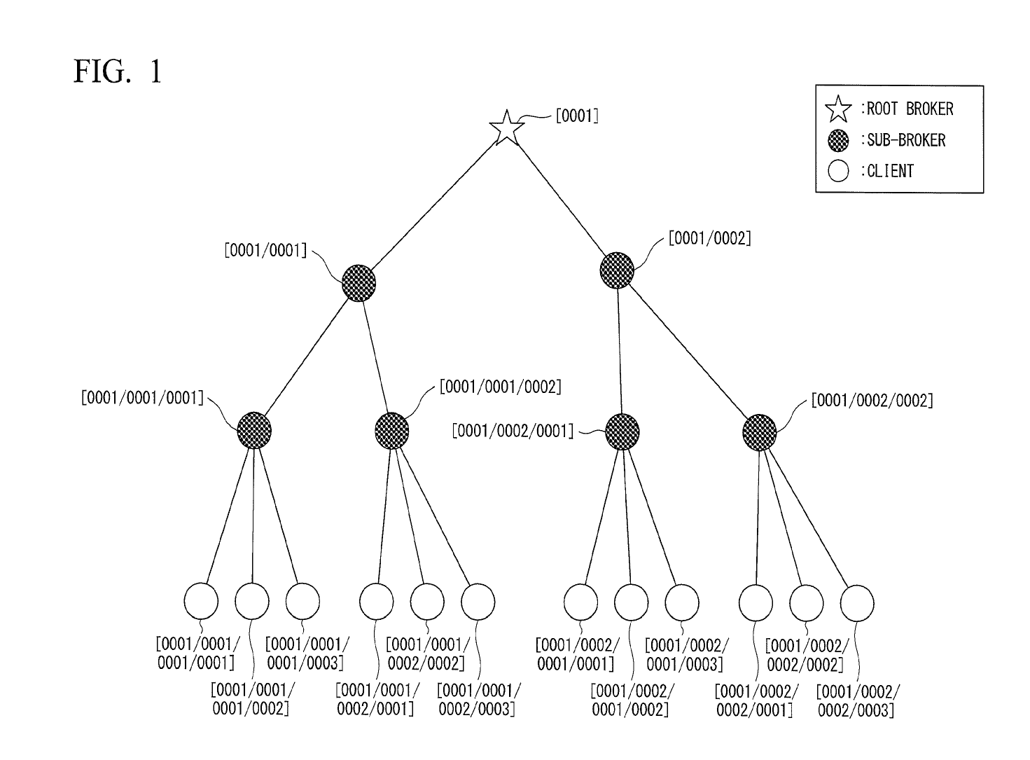

FIG. 1 is a diagram illustrating a logical network forming a tree structure formed by a data delivery system of embodiments. The data delivery system includes at least the following three types of communication devices.

(1) Root broker: a device which receives a delivery request from a publisher and delivers data. This has a publisher function and a broker function in a pub-sub type data delivery system.

(2) Sub-broker (relay device): a device which sends data delivered from a higher broker (root broker or sub-broker) to a lower broker or device. This has a broker function in the pub-sub type data delivery system.

(3) Client (reception device): a device which receives data delivered from a higher broker (the same as above) and plays the data for a user as necessary. This has a subscriber function in the pub-sub type data delivery system.

The pub-sub type data delivery system is a system which, when a client is registered and data destined for the client is generated, automatically delivers the data to the client.

Data is delivered from a root broker to a client through a logical network forming a tree structure. The logical network forming the tree structure refers to a network in which logical addresses (referred to as URIs hereinafter) of communication devices recognized by software operated in the communication devices are branched off from a root broker to clients forming a tree structure. In the figure, [0001] or the like indicates a URI of each communication device. For example, URIs are in a structure in which higher digits indicate higher communication devices like a relationship between a global IP address and a local IP address. In the following description, when “0001” or the like is denoted, this represents a communication device having the URI of “0001.”

In this network, a higher communication device need not necessarily know URIs of all communication devices to clients, and can deliver data as long as a URI of a communication device one level lower to which the corresponding communication device sends data. Accordingly, a communication device of each level knows a URI of a lower communication device to which the corresponding communication device sends data.

A “communication device” in the claims includes at least (2) a sub-broker and may further include (3) a client.

A physical network which constitutes the data delivery system of the present embodiment needs to satisfy the following conditions.

(A) Each communication device is connected to a lower communication device to which the corresponding device sends data.

(B) Each communication device (excluding a root broker and a sub-broker directly connected to the root broker) is connected to a communication device two or more levels higher without passing through a communication device one level higher which sends data to the corresponding communication device.

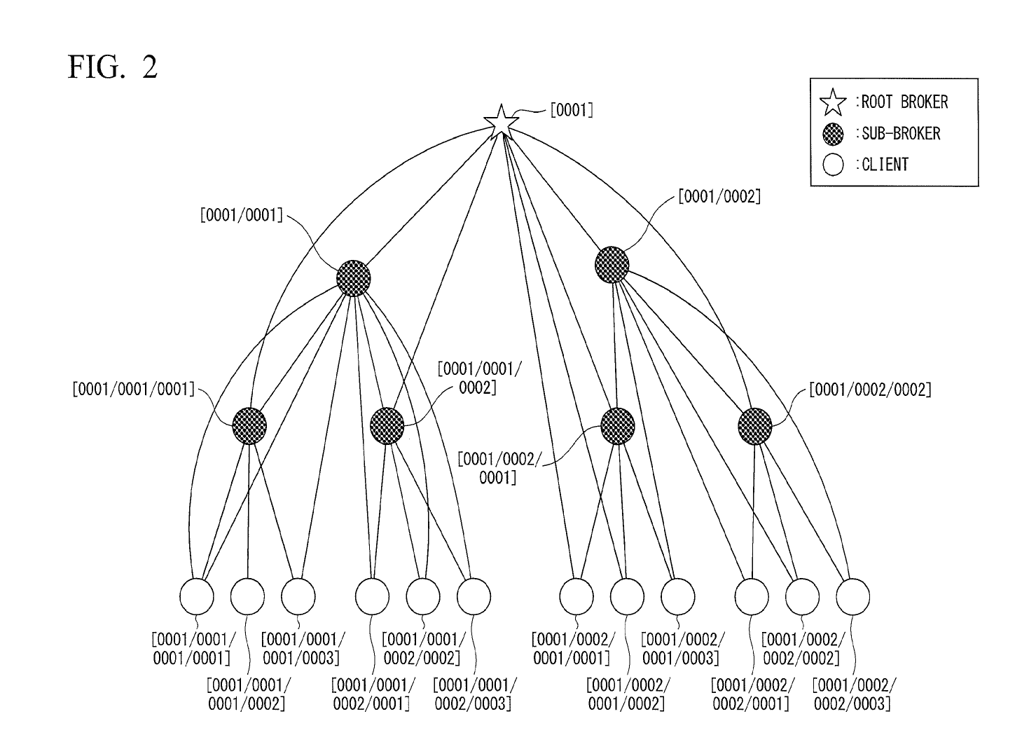

As a physical network which satisfies (A) and (B), for example, a network illustrated in FIG. 2 is conceived. FIG. 2 is a diagram illustrating an example of a physical network formed by the data delivery system. Meanwhile, although FIG. 2 shows a configuration in which communication devices in a relationship between higher and lower communication devices, the data delivery system is not limited thereto and may have a part in which communication devices of the same hierarchy are connected. In addition, when a communication device having particularly high reliability exists in the data delivery system, a lower communication device to which the communication device sends data may not satisfy the condition of (B).

In the following description, data delivered by the data delivery system is referred to as an “event” and label information of an event used to determine the address of the event is referred to as a “topic.”

### [Root Broker]

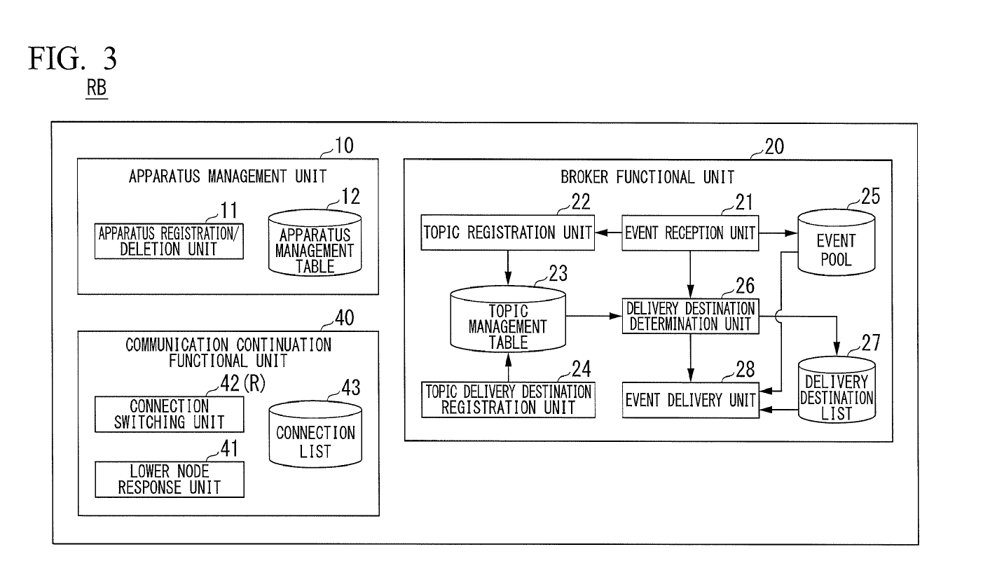

FIG. 3 is a block diagram of a root broker RB. For example, the root broker RB includes an apparatus management unit 10, a broker functional unit 20, and a communication continuation functional unit 40. Meanwhile, an apparatus management table 12, a topic management table 23, an event pool 25, a delivery destination list 27, and a connection list 43 which will be described below are data saved in storage media such as a hard disk drive (HDD), a flash memory and a random access memory (RAM). Further, other components may be realized by executing programs through a processor, for example, a central processing unit (CPU) or the like, Or may be realized by hardware such as large scale integration (LSI), an application specific integrated circuit (ASIC) and a field-programmable gate array (FPGA).

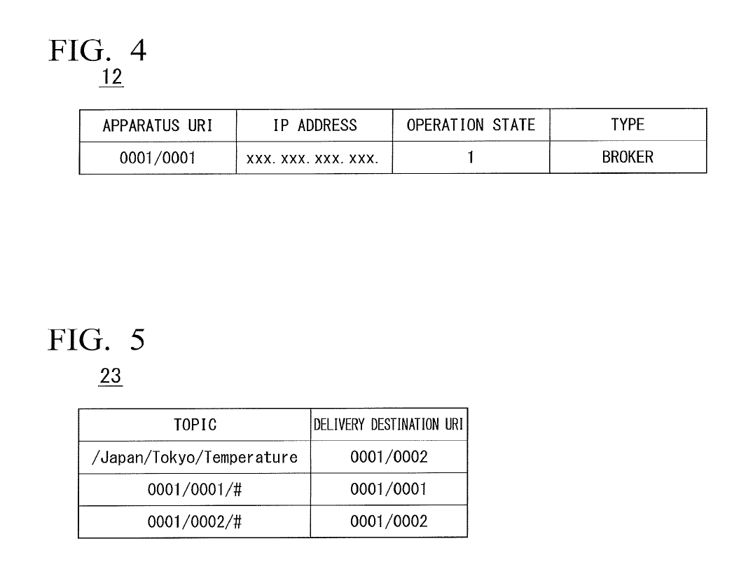

For example, the apparatus management unit 10 includes an apparatus registration/deletion unit 11 and the apparatus management table 12. The apparatus registration/deletion unit 11 acquires a uniform resource identifier (URI) of a lower communication device and registers the URI in the apparatus management table 12 in response to the request of the lower communication device. The URI is set by the root broker RB. FIG. 4 is a diagram illustrating an example of contents of data registered in the apparatus management table 12. The apparatus management table 12 is data in which, for example, a device URI corresponding to a URI of a lower communication device, an IP address, an operation state indicating whether delivery of an event is received, and a type indicating whether it is a broker or a client are associated with one another. For example, the operation state indicates that reception is being performed when set to 1 and indicates that reception is suspended when set to 0.

Referring back to FIG. 3, the broker functional unit 20 includes an event reception unit 21, a topic registration unit 22, the topic management table 23, a topic delivery destination registration unit 24, the event pool 25, a delivery destination determination unit 26, the delivery destination list 27, and an event delivery unit 28, for example.

The event reception unit 21 receives combination data of a topic and an event from a higher device. The topic registration unit 22 extracts the topic from the combination data received by the event reception unit 21 and registers the topic in the topic management table 23.

FIG. 5 is a diagram illustrating an example of content of data registered in the topic management table 23. As shown, the topic management table 23 is data in which delivery destination URIs are associated with topics. A topic may indicate content of a delivered event, such as “/Japan/Tokyo/Temperature (Tokyo weather)” or indicate a URI of a delivery destination. In FIG. 5, “#” means transmission to all URIs which meet previous URIs is performed. In addition, topics may include “send all (send to all connected lower communication devices).”

A delivery destination URI corresponding to a topic is registered by the topic delivery destination registration unit 24. The topic delivery destination registration unit 24 registers the delivery destination URI in the topic management table 23 on the basis of a request from a lower communication device, which has been received in advance, and the content of the topic. For example, with respect to “/Japan/Tokyo/Temperature,” a delivery destination (“0001/0002” in the example of FIG. 5) which notifies of pre-reception of the event of the content is registered in the topic management table 23. In addition, regarding “0001/0001/#,” a delivery destination which satisfies the condition is acquired from the apparatus management table 21 and the URI of the acquired delivery destination is registered in the topic management table 23.

In addition, the event reception unit 21 saves combination data received from a higher device in the event pool 25. The event pool 25 stores combination data of several generations before. Accordingly, when re-delivery is requested due to a communication failure, it is possible to smoothly cope with the request.

The delivery destination determination unit 26 determines an event delivery destination (e.g., IP address) on the basis of topics registered in the topic management table 23 and registers the event delivery destination in the delivery destination list 27, on the basis of an instruction from the event reception unit 21. The event delivery unit 28 delivers an event to a lower communication device on the basis of the delivery destination list 27.

The communication continuation functional unit 40 of the root broker RB includes a lower node response unit 41, a connection switching unit 42 (R), and a connection list 43, for example. The lower node response unit 41 responds to a confirmation signal from a higher node monitoring unit 44 (which will be described below) of a lower communication device. This response is not a mechanical response such as a response to a ping and is suitable to indicate that software of the root broker RB functions normally. For example, the lower node response unit 41 returns a result of a preset operation performed for the confirmation signal to the lower communication device. The connection switching unit 42 (R) changes an event delivery destination in response to the request of a lower communication device. The connection list 43 is a list of lower communication devices connected as event delivery destinations.

### [Sub-Broker]

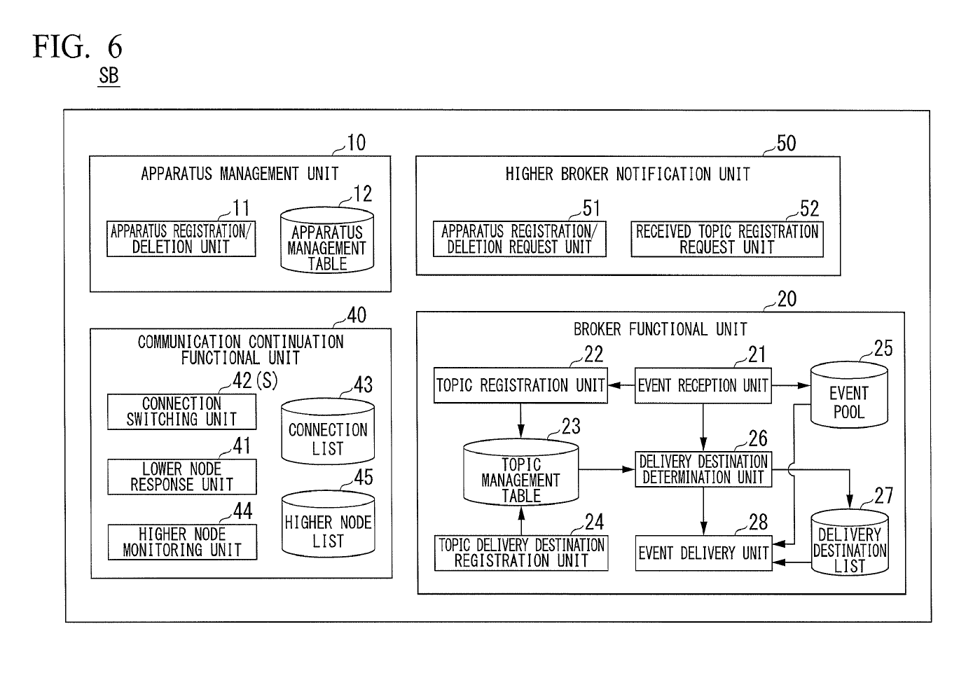

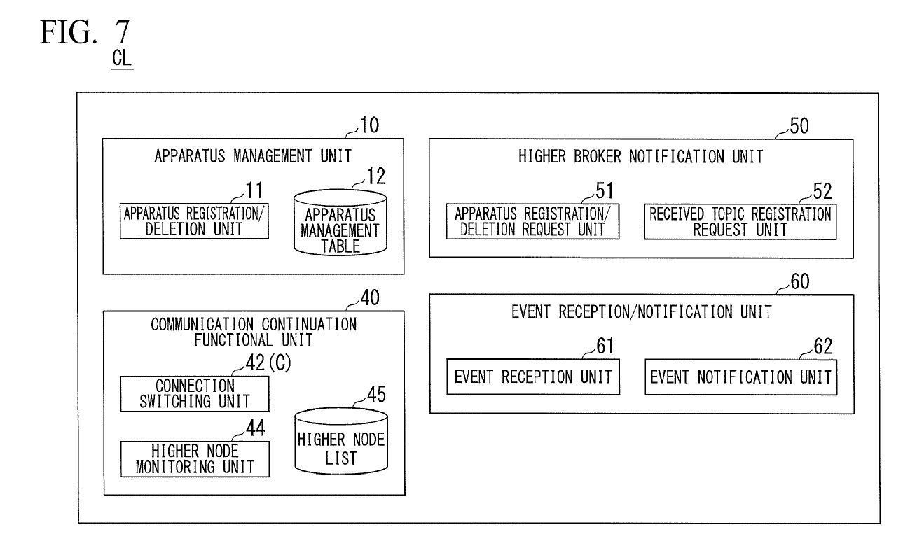

FIG. 6 is a block diagram of a sub-broker SB. In FIG. 6, the same components as those of the root broker RB are denoted by the same numerals. The communication continuation functional unit 40 of the sub-broker SB includes the higher node monitoring unit 44 and a higher node list 45, for example. The higher node monitoring unit 44 sends the aforementioned confirmation signal to a higher communication device which delivers an event to the corresponding device. In addition, when there is no appropriate response from the higher communication device, that is, when the operation state of the communication device which sends an event to the corresponding device is not confirmed, the higher node monitoring unit 44 outputs a notification indicating the aforementioned contents to the connection switching unit 42 (S). The connection switching unit 42 (S) of the sub-broker SB has a function of requesting sending data to the corresponding device for a communication device two or more levels higher in the logical network and can send data to the corresponding device without passing through the communication device whose movable state is not confirmed, with reference to the higher node list 45 when the aforementioned notification is received, in addition to the same function as the connection switching unit 42 (R) of the root broker RB. Details of the higher node list 45 will be described below.

In addition, the sub-broker SB includes a higher broker notification unit 50. For example, the higher broker notification unit 50 includes an apparatus registration/deletion request unit 51 and a received topic registration request unit 52. The apparatus registration/deletion request unit 51 requests registration or deletion of the URI of the corresponding device to the apparatus registration/deletion unit 11 of a higher communication device. The received topic registration request unit 52 requests the topic delivery destination registration unit 24 of a higher communication device to send a specific topic.

### [Client]

FIG. 7 is a block diagram of a client CL. In FIG. 7, the same parts as those of the sub-broker SB are denoted by the same numerals. When a notification from the higher node monitoring unit 44 is sent, a connection switching unit 42 (C) of the client CL requests sending data to the corresponding device for a communication device two or more levels higher in the logical network and can send data to the corresponding device without passing through a communication device whose operation state is not confirmed, with reference to the higher node list 45.

The client CL further includes an event reception/notification unit 60. The event reception/notification unit 60 includes an event reception unit 61 and an event notification unit 62. The event reception unit 61 receives an event from a higher communication device. The event notification unit 62 notifies an end user of the event received by the event reception unit 61.

### [Processing Flow]

Hereinafter, a representative process in the data delivery system will be described.

### (1. Apparatus Registration and Delivery)

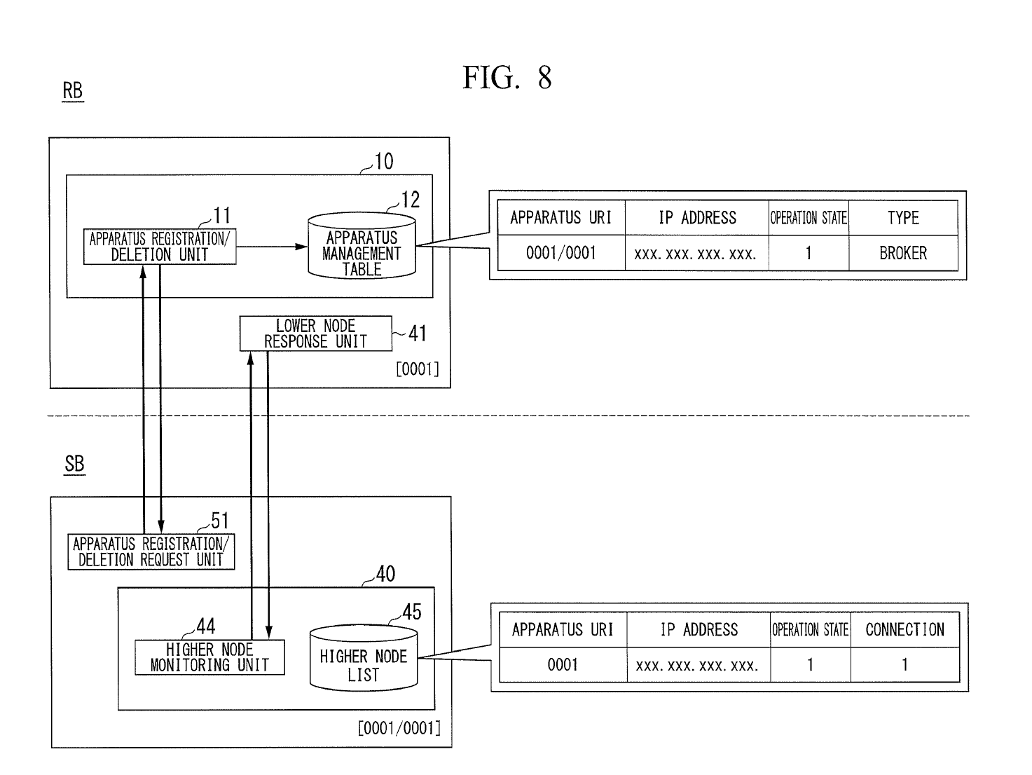

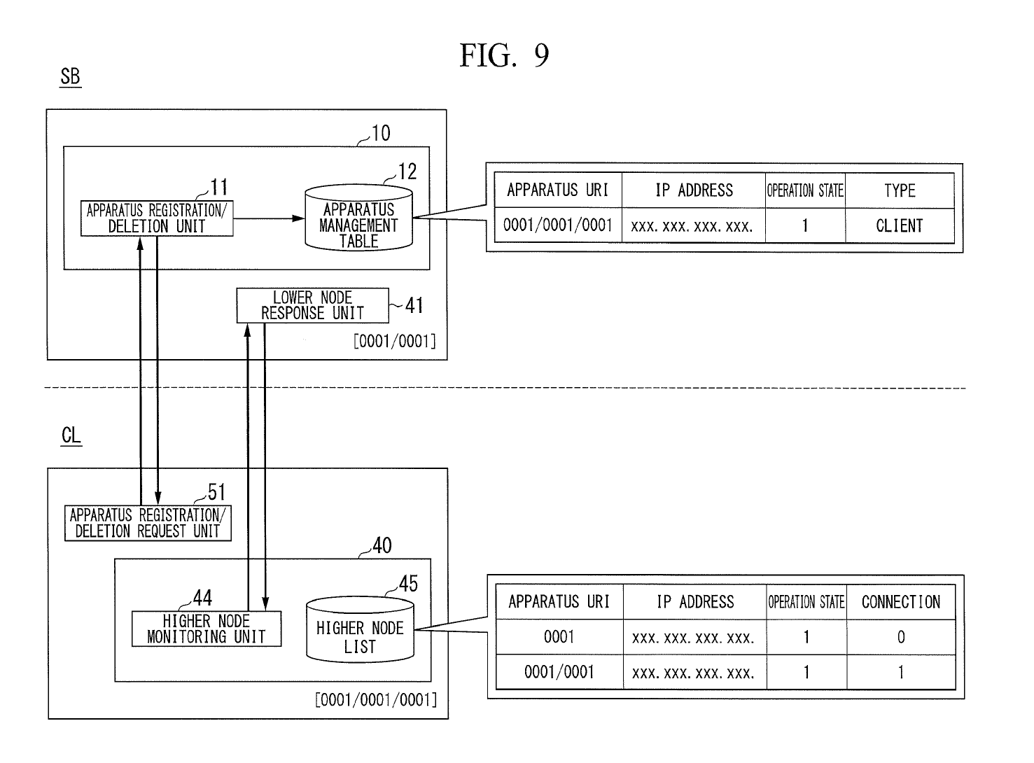

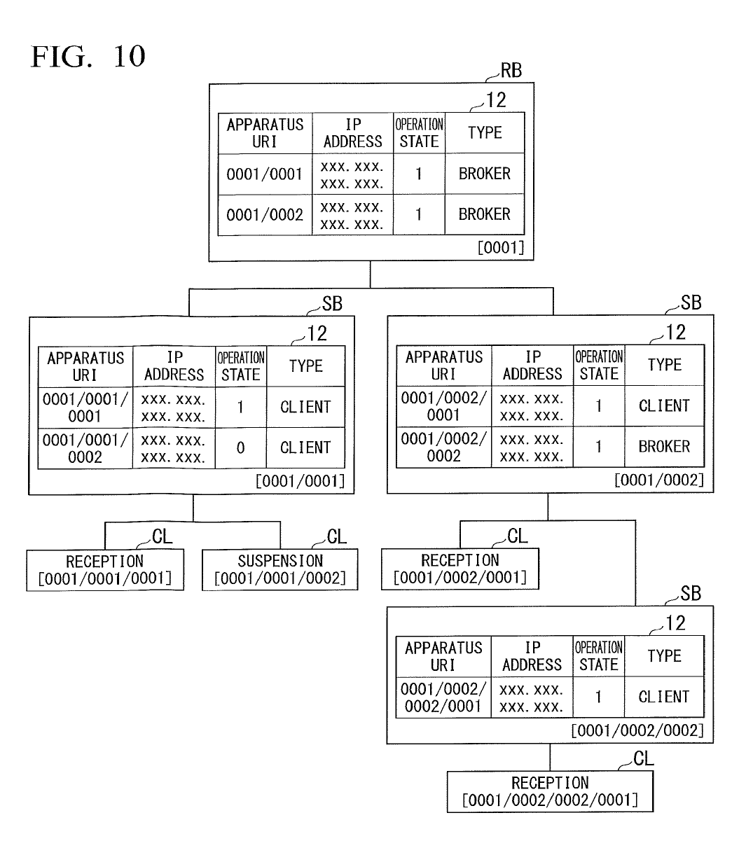

FIG. 8 is a diagram illustrating a state in which an apparatus registration process is performed between brokers. In FIGS. 8 and 9, the data delivery system is described as having three levels of a root broker RB, a sub-broker SB and a client CL. Although FIG. 8 illustrates an apparatus registration process between a sub-broker SB and a root broker RB, the same process is also performed between sub-brokers SB.

First, the apparatus registration/deletion request unit 51 of the sub-broker SB performs a registration request for the apparatus registration/deletion unit 11 of the root broker RB. The apparatus registration/deletion unit 11 of the root broker RB registers an apparatus URI of [0001/0001] of the sub-broker SB, and the like in the apparatus management table 12. Here, the operation state is set to 1 because communication has only been established.

The apparatus registration/deletion unit 11 of the root broker RB sends a response indicating that registration has been completed. The higher node monitoring unit 44 of the sub-broker SB sends a confirmation signal to the lower node response unit 41 of the root broker RB. When the lower node response unit 41 of the root broker RB appropriately replies to the confirmation signal, the higher node monitoring unit 44 of the sub-broker SB registers an apparatus URI of [0001] of the root broker RB, and the like in the higher node list 45.

Information about all communication devices on paths through which events are sent from the root broker RB to the sub-broker SB is registered in the higher node list 45. For example, the higher node list 45 is information in which an apparatus URI, an IP address, an operating state, a connection flag and the like are associated with one another. The apparatus URI and the IP address are provided from the apparatus registration/deletion request unit 51 to the higher node monitoring unit 44. The operation state is information indicating whether a corresponding higher communication device is in an operation state. The operation state is set to 1 when an appropriate response to a confirmation signal is sent and set to 0 otherwise. In addition, the connection flag is information indicating whether a communication device directly sends an event to the corresponding device. The connection flag is set to 1 in the case of a communication device which directly sends an event to the corresponding device and set to 0 otherwise. In the example of FIG. 8, [0001] is in an operation state and thus the operation state thereof is set to 1, and corresponds to a communication device which directly sends an event to [0001/0001] and thus the connection flag thereof is set to 1.

FIG. 9 is a diagram illustrating a state in which an apparatus registration process is performed between a client and a broker. First, the apparatus registration/deletion request unit 51 of a client CL performs a registration request for the apparatus registration/deletion unit 11 of a sub-broker SB. The apparatus registration/deletion unit 11 of the sub-broker SB registers an apparatus URI of [0001/0001/0001] of the client CL, and the like in the apparatus management table 12. Here, the operation state is set to 1 because communication has only been established.

The apparatus registration/deletion unit 11 of the sub-broker SB sends a response indicating that registration has been performed. The higher node monitoring unit 44 of the client CL sends a confirmation signal to the lower node response unit 41 of the sub-broker SB. When the lower node response unit 41 of the sub-broker SB appropriately replies to the confirmation signal, the higher node monitoring unit 44 of the client CL registers an apparatus URI of [0001] of the root broker RB, an apparatus URI of [0001/0001] of the sub-broker SB, and the like in the higher node list 45. Here, since the client CL does not directly know the apparatus URI of the root broker RB, the apparatus registration/deletion unit 11 or the lower node response unit 41 of the sub-broker SB provides information stored in the higher node list 45 of the corresponding device to the client CL, for example. This equally applies to the apparatus registration process between sub-brokers SB.

In the example of FIG. 9, in the higher node list 45 of the client CL, the operation state is set to 1 and the connection flag is set to 0 for the apparatus URI of [0001] of the root broker RB, and the operation state is set to 1 and the connection flag is set to 1 for the apparatus URI of [0001/0001] of the sub-broker SB.

FIG. 10 is a diagram illustrating an example of information set in the apparatus management table 12 of each communication device in a data delivery network in a certain form. Among illustrated clients CL, [0001/0001/0002] suspends reception. Although various reasons for suspension can be conceived, a user of the client CL may suspend the client CL through a manual operation or a failure may occur in the client. The former case is recognized through notification from the client CL to a higher communication device, whereas the latter case is recognized when an event receipt notification (e.g., ACK) from the client CL is not received. The higher communication device sets the operation state of the apparatus management table 12 to 0 for the client CL which suspends reception and stops sending events.

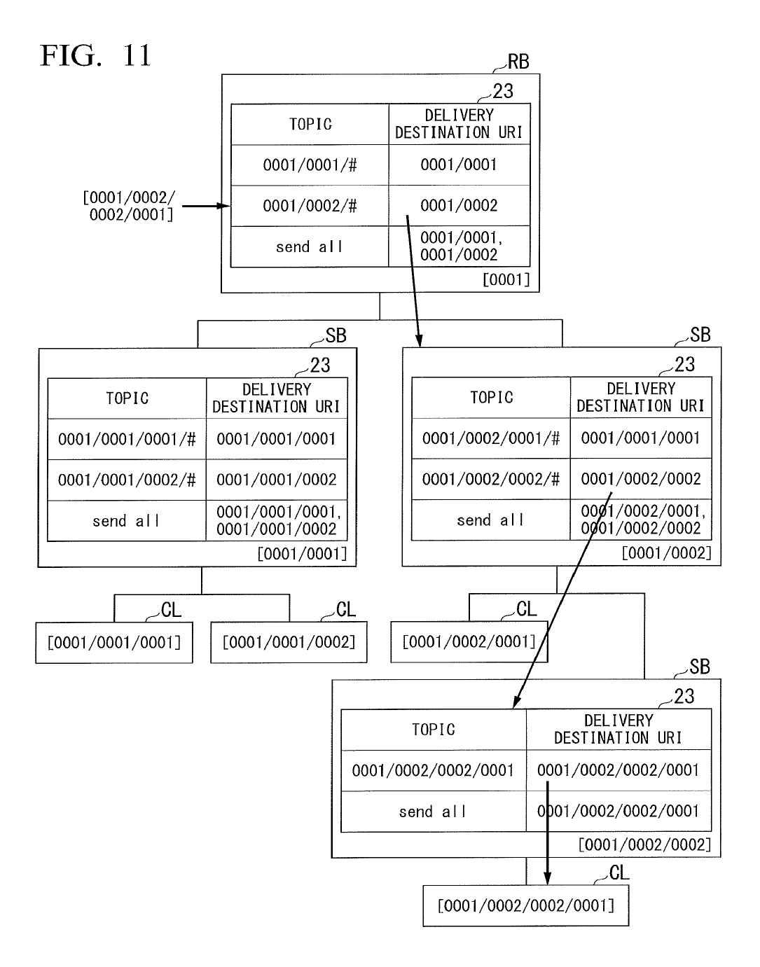

FIG. 11 is a diagram illustrating a state in which a certain event is delivered to a client CL in the data delivery network having the same form as that of FIG. 10. In FIG. 11, an event associated with a topic represented by [0001/0002/0002/0001] is delivered.

In this case, the topic corresponds to [0001/0002/#] in the topic management table 23 of the root broker RB. The event delivery unit 28 of the root broker RB sends an event to [0001/0002] indicated by the delivery destination URI associated with [0001/0002/#] in the topic management table 23.

In the topic management table 23 stored in [0001/0002], [0001/0002/0002/#] corresponds to a topic. The event delivery unit 28 of [0001/0002] sends an event to [0001/0002/0002] indicated by the delivery destination URI associated with [0001/0002/0002/#] in the topic management table 23.

In the topic management table 23 stored in [0001/0002/0002], [0001/0002/0002/0001] corresponds to a topic. The event delivery unit 28 of [0001/0002/0002] sends an event to [0001/0002/0002/0001] indicated by the delivery destination URI associated with [0001/0002/0002/0001] in the topic management table 23. In this manner, an event is delivered to a specific client CL.

### (2. Alternative Delivery)

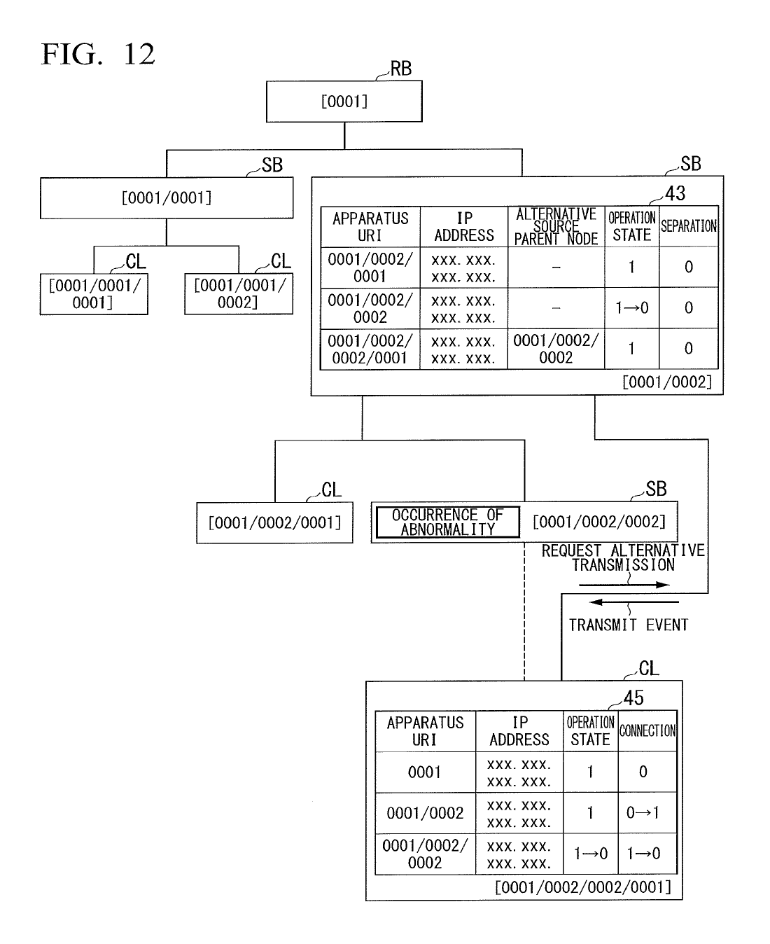

FIG. 12 is a diagram illustrating a state in which alternative delivery is performed when an abnormality occurs in a certain communication device in the data delivery network having the same form as that of FIG. 10. In the figure, an abnormality occurs in [0001/0002/0002]. In this case, [0001/0002/0002/0001] detects that the aforementioned sub-broker SB is not in an operation state through the function of the higher node monitoring unit 44, as described above. The connection switching unit 42 (C) of [0001/0002/0002/0001] asks [0001/0002] which is one level higher than [0001/0002/0002] to perform alternative transmission with reference to the higher node list 45 of the corresponding device. The higher node list 45 of the client CL is as shown in this case, and the operation state and the connection flag of [0001/0002/0002] are changed to 0 and the connection flag of [0001/0002] is changed to 1. Here, the higher node monitoring unit of [0001/0002/0002/0001] suspends sending a confirmation signal to [0001/0002/0002], and simultaneously initiates sending a confirmation signal to [0001/0002]. When there is no appropriate response to the request for alternative transmission from [0001/0002], the connection switching unit 42 (C) of [0001/0002/0002/0001] asks the higher device [0001] to perform alternative transmission.

Meanwhile, in [0001/0002] accepted to perform alternative transmission, the connection list 43 is changed, as shown. The connection list 43 is data in which apparatus URIs, IP addresses, alternative source parent nodes, operation states and separation flags are associated with one another, for example. The alternative source parent node is a URI of a communication device (a communication device in which an abnormality has occurred) which is a source of alternative transmission. The separation flag is information indicating whether a communication device is separated from a data delivery system. Under this setting, [0001/0002] sends an event destined for [0001/0002/0002/0001] to [0001/0002/0002/0001] without passing through [0001/0012/0002].

The connection list 43 is saved in a non-volatile storage device. Accordingly, when a communication device in which an abnormality has occurred is recovered, recovery notification (which will be described below) can be rapidly performed by reading the connection list 43 saved in the non-volatile storage device.

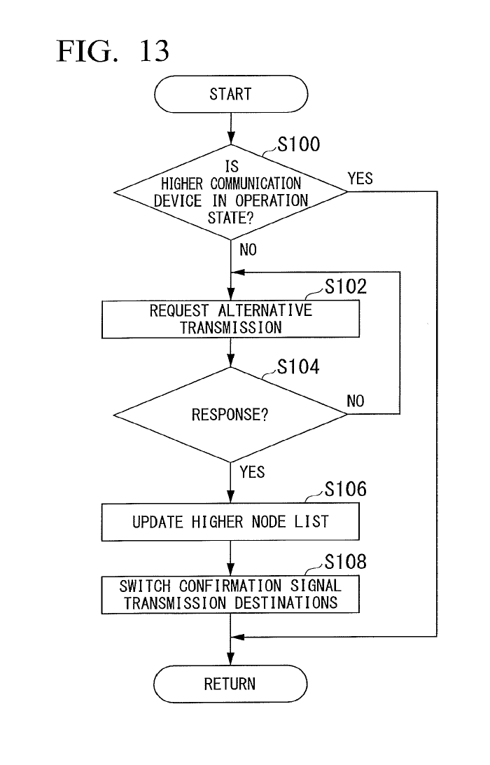

FIG. 13 is a flowchart illustrating an example of a first processing flow executed by the communication continuation functional unit 40. The procedure of the flowchart is repeatedly executed at predetermined intervals, for example. First, the higher node monitoring unit 44 determines whether a higher communication device which sends an event to the corresponding device is in an operation state (step S100). The higher node monitoring unit 44 determines that the higher communication device is not in an operation state, for example, when there is no appropriate response to a confirmation signal for a specific time. When it is determined that the higher communication device which sends an event to the corresponding device is in an operation state, one routine of the present flowchart is ended.

When it is determined that the higher communication device which sends an event to the corresponding device is not in an operation state, the connection switching unit 42 (S or C) sends an alternative transmission request to a communication device one level higher than the communication device determined not to be in an operation state (step S102). Subsequently, the communication switching unit 42 (S or C) determines whether there is a response to the alternative transmission request (step S104). When there is no response to the alternative transmission request, the communication switching unit 42 (S or C) returns to step S102 and sends the alternative transmission request to an even higher communication device.

When there is a response to the alternative transmission request, the communication switching unit 42 (S or C) updates the higher node list 45 (step S106) and switches confirmation signal transmission destinations (step S108). In this manner, event delivery according to alternative transmission can be performed. Meanwhile, when the higher node list 45 is changed and thus the sub-broker SS or the client CL sends a new delivery request or the like, a communication device having a connection flag set to 1 in the higher node list 45 is handled as a transmission destination of the delivery request or the like.

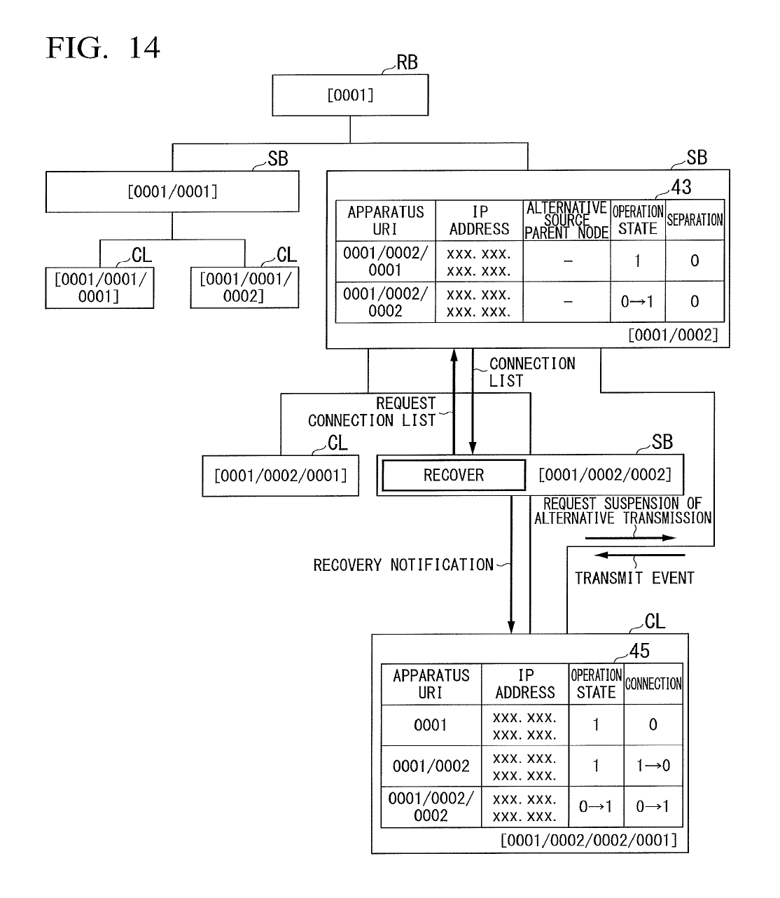

FIG. 14 is a diagram illustrating a state in which a communication device in which an abnormality has occurred is recovered. [0001/0002/0002] sends a recovery notification to [0001/0002/0002/0001] which is a lower device when it recovers from an abnormality state. Upon reception of the recovery notification, the connection switching unit 42 (C) of [0001/0002/0002/0001] sends a request for suspension of alternative transmission to [0001/0002]. Further, [0001/0002/0002] sends a request for sending the connection list 43 to [0001/0002]. [0001/0002] sends the connection list 43 saved in the corresponding device at that time to [0001/0002/0002].

[0001/0002] which has performed event transmission returns the connection list 43 to the original state upon reception of the request for suspension of alternative transmission. [0001/0002/0002] searches for a lower communication device having an operation flag or a separation flag which is set to 1, and when there is such a lower communication device, also changes the operation flag or separation flag to 1 in the connection list 43 stored in the corresponding device. Accordingly, event transmission to a lower device which suspends reception can be suspended and thus unnecessary communication can be suppressed.

### Application Examples

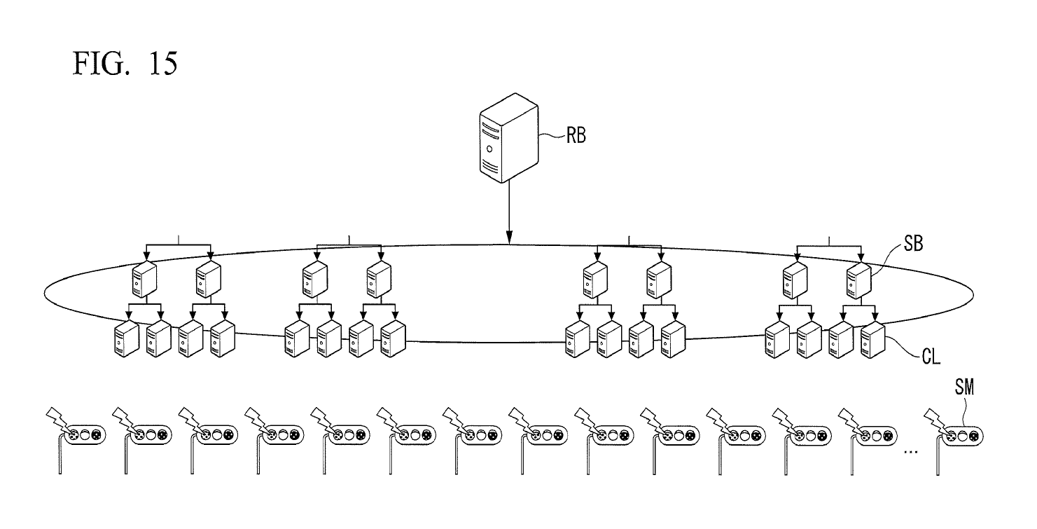

FIG. 15 is a diagram illustrating an example in which the data delivery system of embodiments is applied to traffic signal control system. As shown, control signals of traffic signals SM may be delivered by a root broker RB to clients CL via sub-brokers SB one level higher than the clients CL, and the traffic signals SM may be controlled by the clients CL. In this case, control parts of the traffic signals SM may be clients CLs. Accordingly, it is possible to easily perform control such that some of signal groups are simultaneously switched to red lights when an emergency vehicle passes by. Furthermore, it is possible to accurately deliver data according to alternative transmission even when failure occurs in some communication devices in the event of a disaster.

In the above description, a communication device in which an abnormality has occurred is not involved in alternative transmission. The present invention is not limited thereto, and when “a function of performing transmission by monitoring a URI remains without damage despite broker software not operating normally,” for example, the communication device may relay alternative transmission.

According to at least one of the above-described embodiments, in a data delivery system including a plurality of communication devices and performing data delivery using a logical network forming a tree structure, at least some of the plurality of communication devices include: the higher node monitoring unit 44 which monitors an operation state of a communication device one level higher in the logical network forming the tree structure and sends data to the corresponding device; and the connection switching unit 42 which, when the operation state of the communication device one level higher is not confirmed by the higher node monitoring unit 44, requests sending data to the corresponding device for a communication device two or more levels higher in the logical network forming the tree structure and can send data to the corresponding device, without passing through the communication device one level higher, and thus it is possible to rapidly switch to an alternative path when an abnormality occurs.

Although several embodiments of the present invention have been described above, such embodiments are presented as examples and are not intended to limit the scope of the present invention. Such embodiments can be implemented in other various aspects, and additions, omissions, substitutions, and other modifications thereof can be made without departing from the spirit or scope of the present invention. Such embodiments and modifications thereof are included in the invention and the equivalents thereof disclosed in claims as being included in the scope and the essential point of the invention.

What is claimed is:

1. A data delivery system comprising a plurality of communication devices, comprising a first communication device, a second communication device, and a third communication device, and performing data delivery using a logical network forming a tree structure, the second communication device being in one level higher than the first communication device in the logical network and sending data to the first communication device, the third communication device being in two or more levels higher than the first device in the logical network and being configured to send data to the first communication device without passing through the second communication device,
the first communication device comprising:
a monitoring unit configured to monitor an operation state of the second communication device; and
a connection switching unit configured to send a request for sending data to the third communication device, in a case that the normal operation state of the second communication device is not confirmed by the monitoring unit.

2. The data delivery system according to claim 1,
wherein the first communication device stores a first list which is a list of communication devices in one or more level higher than the first communication device in the logical network, the first list including the second communication device and the third communication device, and
wherein the connection switching unit is configured to specify a communication device which operates as the third communication device with reference to the first list when the normal operation state of the second communication device is not confirmed by the monitoring unit.

3. The data delivery system according to claim 1,
wherein the monitoring unit is configured to periodically monitor the operation state of the second communication device.

4. The data delivery system according to claim 1,
wherein the third communication devices stores a second list which is a list indicating operation states of communication devices in one or more level lower than the third communication device in the logical network, the second list including the operation states of the first communication device and the second communication device,
wherein the third communication device is configured to update the second list depending on a state of the first device while data is sent to the first communication device in response to the request, and to send the updated second list to the first communication device when the second communication device is recovered to the normal operation state.

5. The data delivery system according to claim 1,
wherein, among the plurality of communication devices, a communication device at a highest level in the logical network comprises a publisher function and a broker function, a communication device at a middle level in the logical network comprises the broker function, and a communication device at a lowest level in the logical network comprises a subscriber function.

6. A communication device comprising:
a monitoring unit configured to monitor an operation state of a second communication device, the second communication device being in one level higher than the communication device in a logical network forming a tree structure and sending data to the communication device; and
a connection switching unit configured to, when the normal operation state of the second communication device is not confirmed by the monitoring unit, send a request for sending data to a third communication device, the third communication device being in two or more levels higher than the communication device in the logical network and being configured to send data to the communication device, without passing through the second communication device.

7. A communication control method of a first communication device of a data delivery system comprising a plurality of communication devices, comprising the first communication device, a second communication device, and a third communication device, and performing data delivery using a logical network forming a tree structure, the second communication device being in one level higher than the first communication device in the logical network and sending data to the first communication device, the third communication device being in two or more levels higher than the first communication device in the logical network and being configured to send data to the first communication device without passing through the second communication device, comprising:
monitoring an operation state of the second communication device; and
sending a request for sending data to the third communication device, in a case that the normal operation state of the second communication device is not confirmed.
